(19) United States
(12) Patent Application Publication
(10) Pub. No.: US 2010/0023772 A1
(43) Pub. Date: Jan. 28, 2010

(54) METHOD FOR GENERATING A ONE-TIME ACCESS CODE

(75) Inventor: Axel Doering, Jena (DE)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: CARL ZEISS MEDITEC AG, Jena (DE)

(21) Appl. No.: 12/374,924

(22) PCT Filed: Jul. 19, 2007
(86) PCT No.: PCT/EP2007/006408

§ 371 Date: Jan. 23, 2009

(30) Foreign Application Priority Data
Jul. 26, 2006 (DE) 102006034535.5

(51) Int. Cl. H04L 9/32

(52) U.S. Cl. 713/171

(57) ABSTRACT

A method for generating an access code for a device or system. The one-time access code generated by the method for the device or system is valid only once. The method can be used for supplying goods or services by means of automatic or semiautomatic access control devices or systems, for example.

### PRIORITY CLAIM

The present application is a National Phase entry of PCT Application No. PCT/EP2007/006408, filed Jun. 19, 2007, which claims priority from German Application Number 102006034535.5, filed Jul. 26, 2006, the disclosures of which are hereby incorporated by reference herein in their entirety.

### FIELD OF THE INVENTION

The invention relates to a method for generating an access code for a device, the access code being valid only once. The method can be used for supplying goods or services by means of automatic or semiautomatic access control devices or systems, for example.

### BACKGROUND OF THE INVENTION

Goods and services are increasingly offered and sold on a virtual basis. Thereby, virtual refers to the fact that seller and buyer no longer come in contact in the traditionally usual way but solely through an electronic medium, such as the Internet. It is known to digitally encode, e.g., software products, pieces of music, or films, and to make generally accessible as encoded file. In order to be able to consume such a piece of music or film, the buyer must purchase a digital key from the seller for the encoding of the file. Only with the help of said key does the content of the file once again become accessible and can be presented to the buyer.

Methods for generating such keys are known, e.g., from U.S. Pat. No. 6,865,555, WO 2005/041608, and US 2005/0114272.

Thereby, the seller very often requests for the key to become invalid after a one-time use, so that third parties, to whom the key is disclosed, are prevented from also decoding the freely accessible file.

There are analog requirements when the digital content is made accessible via streaming and the key serves online decoding purposes.

Such one-time access codes are also needed when real goods or shipments are kept ready for pickup from a self-serve depot, whereby the buyer or recipient shall only have access to exactly the goods purchased by or intended for such buyer.

In order to solve such problems, several solutions are known. In U.S. Pat. No. 6,300,873 it is suggested that the access code is chosen from a list of possible codes, which are stored in the device. After the code is used, a new list of codes is transmitted from the central server to the device. Thereby, it is disadvantageous that after every use of a code, the entire list is updated, and the access codes are transmitted as such in advance. If they are intercepted during such a transmission, security is no longer guaranteed.

In U.S. Pat. No. 6,581,161 a solution is suggested, whereby the access code is generated server-side upon request by a user and transmitted to the user as well as the device; therefore, both must be connected to the server via a network connection.

U.S. Pat. No. 5,140,317 describes a solution whereby a key with a memory circuit must be available, and the access code filed in the memory is erased after opening of the device. Thereby, the key must be provided with a new access code prior to the next use, which generally requires that a direct connection to the central server for issuing of the access code be established.

### SUMMARY OF THE INVENTION

The task of the invention is to overcome the disadvantages of the prior art and to provide a method for generating an access code for a device or system, which is no longer valid after a one-time use, and which does not necessarily require an online connection between the device and the unit generating said access code.

Said task is solved through a method for generating an access code for a device or system, said access code being valid only once, which includes the following steps:

a) Device-internal generating of a query key from at least one device-internal identification;

b) Transmission of the query key to an authorization entity;

c) Generation of a release key from the query key through the authorization entity;

d) Transmission of the release key to the device;

e) Release of access through the device; and

f) Device-internal random change of the at least one device-internal identification.

Thereby, it is advantageous if the random change of at least one device-internal identification is achieved by generating the identification by means of a random number generator.

Alternatively, the random change of at least one device-internal identification can be achieved with the random selection from a predefined list of identifications.

Thereby, the transmission of the query key and/or the transmission of the release key can be achieved via data carrier or online data transfer.

According to the invention, the suggested method for generating an access code can be used for a supply unit for goods after the sale of said goods, release of digital information, generating an access password for a device-internal software or for information stored in said device, as well as for generating codes for opening doors of security areas. Many other uses of the method, according to the invention, are also possible in order to restrict passwords or access codes to a one-time use.

Advantageously, the authorization entity is a computer or other data processing unit, which is accessible to the supplier or seller, and which is capable of verifying in known fashion the authorization for the access code request, e.g, through verification of payment for the digital contents or the existence of a respective agreement with the person requesting said access code.

In the following, the invention is explained by means of a particular embodiment.

### BRIEF DESCRIPTION OF THE DRAWINGS

FIG. 1 shows schematically the sequence of the method, according to an embodiment of the invention.

### DETAILED DESCRIPTION

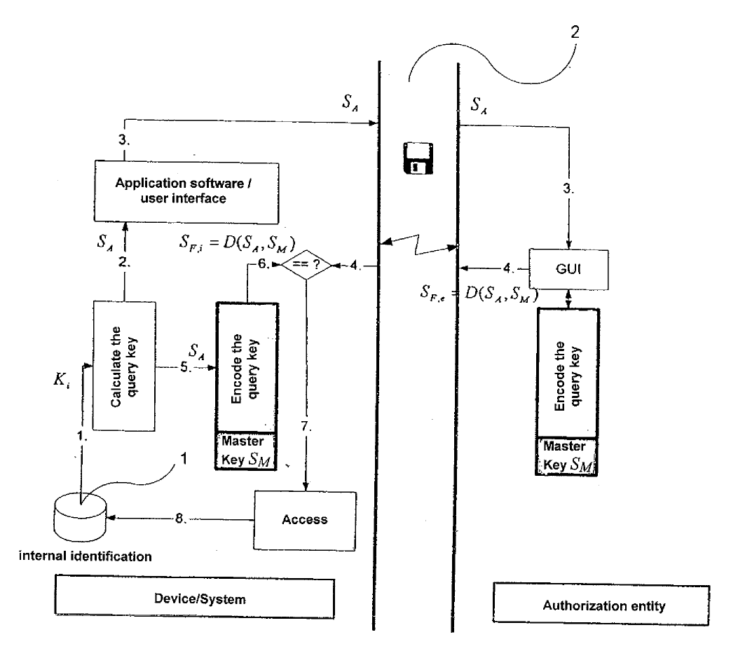

Referring to FIG. 1, the device or system contains a memory 1, which contains at least one (with sufficient probability) unique, preferably unpredictable internal identification Kᵢ. From said identification Kᵢ, a query key S_{A}(Kᵢ) is generated by a computer unit. This can be a chain of characters or a sequence of numbers or similar combinations of arbitrary length, whereby it is advantageous to use at least 10 characters; alternatively, it can also consist of a byte sequence, which also contains non-displayable characters. Said query key is sent to the authorization entity via a preferably secure channel (e.g., mail, telephone, signed email, data carrier). E.g., said authorization entity can be a location of the supplier of the goods or services, which is capable of verifying the authorization of the query (identity and authorization of the sender for requesting an access code to the goods or services, executed agreement, received payment, etc).

From said query key a release key S_{F,e}=D(S_{A}, S_{M}) is generated by means of a secret masterkey S_{M}, using a suitable encryption method D(S_{A}, S_{M}), e.g., with a computer; in turn, said release key is transmitted via a secure channel back to the customer.

The same encryption method and the same (secret) masterkey are implemented in the software of the device, therefore, the release key S_{F,i}=D(S_{A}, S_{M}) can be calculated internally and not visible for the user. If the comparison of the release key, entered by the user or received by the device/system and calculated by the authorization entity, results in the parity S_{F,e}=S_{F,i}, access to the goods or services or the digital contents is enabled, and the internal identification Kᵢ is selectively, but not predictably, changed.

The repetition of said process on the same/a different device would generate a different query key due to the changed or different internal identification, As a result, the previously used release key is useless, and can therefore not be misused.

The suggested solution can be expanded in several directions, e.g., through electronic storage and/or transmission of the query key and the release key directly from the device software (e.g., as email or export/import to/from a file, but also online via an existing internet connection).

Furthermore, an automatic change of the internal identification, which is independent from the entry of a valid release key, can be available for certain greater intervals (e.g., once a month). This way, unused release keys would be automatically invalidated after the expired time period and, therefore, pose no risk for unauthorized use.

The method for determining the internal identification Kᵢ can be varied greatly. Feasible examples include:
Combination of timestamp, device identification (e.g., serial number) and a random number;
Use of hash-functions (e.g., MD5 or SHA) for constant user identity data in combination with a random number;
Use of constants (e.g., UID'S) from the device operating system in combination with a random number.

Furthermore, the method can be modified or extended for generation and/or comparisons of the release keys. A signature check instead of a parity test is feasible, e.g., through the use of an asymmetrical encryption method, such as RSA, whereby the transmitted query key is encoded in the release key together with the “public” key, and the release key is decoded in the data-storing device by means of the “private” key, and the decoding result is compared to the query key. The terms “public” and “private” keys herein refer to the terminology common in cryptography: In the above case, both keys were to be kept secret.

1. A method for generating an access code for a device or system, said access code being valid only once, said method comprising:
a) Device-internal generation of a query key from at least one device-internal identification;
b) Transmission of the query key to an authorization entity;
c) Generation of a release key from the query key through the authorization entity;
d) Transmission of the release key to the device;
e) Release of access through the device; and
f) Device-internal random change of the at least one device-internal identification.

2. The method for generating an access code, according to claim 1, wherein the random change of the at least one device-internal identification is achieved by generating the identification using a random number generator.

3. Method for generating an access code, according to claim 1, wherein the random change of the at least one device-internal identification is achieved with a random selection from a predefined list of identifications.

4. The method for generating an access code, according to claim 1, wherein at least one of the transmission of the query key and the transmission of the release key is achieved via data carrier or online data transfer.

5. A method for the selling of goods, wherein the access code for a supply unit for goods is generated using the method of claim 1.

6. A method for the release of digital information for a user, wherein the access code for the digital information is generated using the method of claim 1.

7. The method for generating an access code, according to claim 2, wherein at least one of the transmission of the query key and the transmission of the release key is achieved via data carrier or online data transfer.

8. The method for generating an access code, according to claim 3, wherein at least one of the transmission of the query key and the transmission of the release key is achieved via data carrier or online data transfer.

9. A method for the selling of goods, wherein the access code for a supply unit for goods is generated using the method of claim 2.

10. A method for the selling of goods, wherein the access code for a supply unit for goods is generated using the method of claim 3.

11. A method for the selling of goods, wherein the access code for a supply unit for goods is generated using the method of claim 4.

12. A method for the release of digital information for a user, wherein the access code for the digital information is generated using the method of claim 2.

13. A method for the release of digital information for a user, wherein the access code for the digital information is generated using the method of claim 3.

14. A method for the release of digital information for a user, wherein the access code for the digital information is generated using the method of claim 4.

15. The method of claim 1, wherein the authorization entity is a computer of a supplier of the goods or services that is capable of authorizing access.

16. A secure-access device for facilitating the sale of goods, comprising:
means for generating a query key from a device internal identification associated with the secure-access device;
means for transmitting the query key to an authorization entity;
means for receiving a release key from the authorization entity, wherein the release key is generated by the authorization entity using the query key; and
means for changing the device-internal identification at the secure-access device following release of access to the protected data.

17. The device of claim 16, wherein the authorization entity is a supplier computer.

18. The device of claim 16, wherein a change of the device-internal identification is automatic after a predetermined time interval if the release key is not used.

19. The device of claim 18, wherein the predetermined time interval is one month.

20. The device of claim 16, wherein the device internal identification is a unique identification.
